(19) United States
(12) Patent Application Publication
(10) Pub. No.: US 2020/0346867 A1
(43) Pub. Date: Nov. 5, 2020

(54) CARGO SORTER OF OPENING AND CLOSING METHOD WITH SLIDING AND METHOD FOR SORTING CARGO USING THE CARGO SORTER

(71) Applicant: Gachisoft Inc., Daejeon (KR)

(72) Inventor: Ho Yon KIM, Sejong (KR)

(73) Assignee: Gachisoft Inc., Daejeon (KR)

(21) Appl. No.: 16/642,103

(22) PCT Filed: Feb. 13, 2020
(86) PCT No.: PCT/KR2020/001995

§ 371 Date: Feb. 28, 2020

(30) Foreign Application Priority Data
May 5, 2019 (KR) 10-2019-0059656

(51) Int. Cl. B65G 1/137

(52) U.S. Cl. CPC B65G 1/1373

(57) ABSTRACT

Disclosed are a slidably openable or closable type cargo sorter and a method of sorting cargo using the same. The cargo sorter includes a plurality of divided sections which form a separate space, a plurality of slidable opening or closing devices which each have an inclined surface formed in a row at a position corresponding to each of the divided sections to be inclined as an openable or closable door so as to transfer cargo using the inclined surface and to sort the cargo by changing an approach path of the cargo by opening the door, a position determination portion configured to determine a cargo proceeding path including a destination section where the cargo is finally discharged and to control movement of the cargo along the determined proceeding path, and an opening or closing control portion configured to control opening or closing of each of the slidable opening or closing devices so as to discharge the cargo into the destination section determined by the position determination portion.

### TECHNICAL FIELD

The present invention relates to a logistics technique, and more particularly, to a cargo transfer and sorting technique.

### BACKGROUND ART

A need for cargo disposition at a high-speed has been on the increase according to a growth of delivery service market and building of a foothold type distribution center. Cargo disposition at a distribution center has evolved from being partially automated to being completely automated. Accordingly, a need for a cargo sorter configured to automatically sort cargo is increasing.

The cargo sorter includes a conveyer configured to convey cargo and divided sections in which cargo conveyed from the conveyer is loaded. Generally, positions of the divided sections are fixed and the conveyer conveys and sorts cargo and loads the cargo in a position of a corresponding divided section. As types of cargo to be sorted increase, it is necessary to increase the number of discharge chutes configured to discharge cargo and the number of such divided sections. Here, when the number of discharge chutes is simply increased like a conventional case, an installation cost and an installation scale are also increased.

### DISCLOSURE

### Technical Problem

The present invention is directed to providing a cargo sorter capable of minimizing an installation cost and an installation scale for sorting cargo and a method of sorting cargo using the same.

### Technical Solution

One aspect of the present invention provides a cargo sorter including a plurality of divided sections which form a separate space, a plurality of slidable opening or closing devices which each have an inclined surface formed in a row at a position corresponding to each of the divided sections to be inclined as an openable or closable door so as to transfer cargo using the inclined surface and to sort the cargo by changing an approach path of the cargo by opening the door, a position determination portion configured to determine a cargo proceeding path including a destination section where the cargo is finally discharged and to control movement of the cargo along the determined proceeding path, and an opening or closing control portion configured to control opening or closing of each of the slidable opening or closing devices so as to discharge the cargo into the destination section determined by the position determination portion.

The slidable opening or closing devices may be installed in a row on top ends of the divided sections to be inclined as the openable or closable doors so as to transfer the cargo by sliding the cargo thereon when they are closed and to drop the cargo through an open space toward the divided section therebelow when they are opened.

The opening or closing control portion may separately control operations of the slidable opening or closing devices at the same time using a single driving portion commonly used by the slidable opening or closing devices.

When the driving portion is driven, the opening or closing control portion may selectively apply an electrical signal to a solenoid and determine whether to open or close each of the slidable opening or closing devices.

The opening or closing control portion may include a single driving portion including a cylinder or a motor, a link structure including a fixing bar, fixing shafts mounted on both ends of the fixing bar, a moving bar formed to be spaced apart to be parallel from the fixing bar and coupled with the driving portion to be moved by driving of the driving portion, links mounted on both ends of the moving bar, and a connection member configured to connect the fixing shafts to the links, a plurality of first solenoids formed between both of the links of the moving bar to move while the links move, and a plurality of second solenoids each mounted in a position corresponding to each of the first solenoids for each of the slidable opening or closing devices to generate a coupling force with the first solenoid due to an electrical signal and move with the first solenoid, in which the coupling force with the first solenoid is released when the electrical signal is not generated. Also, when the first solenoid and the second solenoid, which correspond to each other, are coupled with each other, a door of the corresponding slidable opening or closing device may be openable or closable, and when coupling between the first solenoid and the second solenoid is released, the door of the corresponding slidable opening or closing device may not move and may stop in the present state with no regard to the driving portion.

The opening or closing control portion may include a single driving portion including a cylinder or a motor, a link structure including a fixing bar, fixing shafts mounted on both ends of the fixing bar, a moving bar formed to be spaced apart to be parallel from the fixing bar and coupled with the driving portion through a power transmission portion to be moved by driving of the driving portion, links mounted on both ends of the moving bar, and a connection member configured to connect the fixing shafts to the links, the power transmission portion configured to connect the driving portion, the fixing bar, and the moving bar and to move the moving bar by rotating on a fixing shaft of the fixing bar when the driving portion is driven, a plurality of first solenoids formed between both of the links of the moving bar to move while the links move, and a plurality of second solenoids each mounted in a position corresponding to each of the first solenoids for each of the slidable opening or closing devices to generate a coupling force with the first solenoid due to an electrical signal and move with the first solenoid, in which the coupling force with the first solenoid is released when the electrical signal is not generated. Also, when the first solenoid and the second solenoid, which correspond to each other, are coupled with each other, a door of the corresponding slidable opening or closing device may be openable or closable, and when coupling between the first solenoid and the second solenoid is released, the door of the corresponding slidable opening or closing device may not move and may stop in the present state with no regard to the driving portion.

Before the cargo approaches the destination section, previous slidable opening or closing devices, which are closed, may sequentially transfer the cargo to the next slidable opening or closing devices, and the slidable opening or closing device located on the top end of the destination section may be opened so as to load the cargo on a destination section at a bottom end thereof.

The cargo sorter may further include a transfer portion configured to transfer or divert the cargo. Here, the divided sections may form a space separated from an approach position, in which the cargo transferred or diverted by the transfer portion drops or slides. Also, the slidable opening or closing devices may be formed between the transfer portion and the divided sections.

Another aspect of the present invention provides a method of sorting cargo. The method includes determining a certain destination section, on which the cargo is to be loaded, among a plurality of divided sections, driving a single driving portion, applying an electrical signal to a slidable opening or closing device corresponding to the determined destination section while the driving portion is driven, and loading the cargo on the destination section through an opened space as the slidable opening or closing device to which the electrical signal is applied is opened.

In the operation of applying the electrical signal, in the case of the slidable opening or closing device to which the electrical signal is applied, a first solenoid and a second solenoid, which are formed in positions corresponding to each other, may be coupled with each other such that the first solenoid or the second solenoid, which is coupled with the corresponding slidable opening or closing device, move and open or close a door of the corresponding slidable opening or closing device. In the case of other slidable opening or closing devices to which the electrical signal is not applied, coupling between a first solenoid and a second solenoid, which correspond to each other, is released such that doors thereof may remain without change.

### Advantageous Effects

According to one embodiment, in a cargo sorter and a method of sorting cargo using the same, slidable opening or closing devices with openable or closable doors may be arranged in a row to use inclined surfaces thereof as a transfer unit and cargo may be sorted by opening the doors so as to obtain an effect of extending a discharge chute at a low cost and to reduce an installation cost and an installation scale.

A method of selectively applying an electrical signal to solenoids corresponding to each other to open or close a door of a corresponding slidable opening or closing device when solenoids are coupled with each other may be used such that a structure thereof is simple and it is possible to separately control each of slidable opening or closing devices.

Also, cargo may be controlled to be discharged into a plurality of divided sections using only a single driving portion (for example, a motor, a cylinder, or the like) so as to control at a low cost without an increase in a control cost (for example, a discharge motor, cylinder, or the like) even when the number of such divided sections increases while the cargo is treated. In addition, the cargo sorter sorts cargo by diverting the cargo and discharges and loads the cargo in a destination section among a plurality of divided sections so as to increase the number of such divided sections in a limited space and to reduce an installation cost. For example, the cargo may be sorted and loaded by changing an approach path of the cargo to a destination section such that the cargo is sorted and loaded on the corresponding destination section among such divided sections. In this case, since the divided sections are extendable along an outline of the cargo sorter not only in a longitudinal direction but also in a vertical direction perpendicular to the longitudinal direction, an installation cost and an installation scale may be reduced.

### DESCRIPTION OF DRAWINGS

FIG. 1 is a view illustrating a configuration of a cargo sorter according to one embodiment of the present invention;

FIG. 2 is a side view illustrating the cargo sorter according to one embodiment of the present invention;

FIG. 3 is a side view illustrating a driving device of FIG. 2 according to one embodiment of the present invention;

FIGS. 4 to 6 are views illustrating a detailed structure of the driving device of FIG. 2 according to one embodiment of the present invention;

FIGS. 7 and 8 are views illustrating a detailed structure of the driving device of FIG. 2 according to another embodiment of the present invention; and

FIG. 9 is a flowchart illustrating a cargo sorting method according to one embodiment of the present invention.

### MODES OF THE INVENTION

The advantages and features of the present invention and a method of achieving the same will become clear with reference to the attached drawings and the following embodiments which will be described below in detail. However, the present invention is not limited to the embodiments which will be described below and may be implemented as a variety of different shapes. It should be noted that the embodiments are provided merely for completing the disclosure of the present invention and allowing one of ordinary skill in the art to understand the complete scope of the present invention and the present invention will be defined by the claims. Throughout the specification, like reference numerals refer to like elements.

In a description of the embodiments of the present invention, a detailed description of well-known functions or components of the related art will be omitted when it is deemed to obscure the essence of the present invention. Also, terms used herein are defined in consideration of the functions of the embodiments of the present invention and may be changed depending on a user, the intent of an operator, or a custom. Accordingly, the terms should be defined based on the following overall description of this specification.

Since combinations of blocks of an attached block diagram and operations of an attached flowchart may be executed by computer program instructions (execution engine) and computer program instructions may be loaded on a processor of a universal computer, a special-purpose computer, or other programmable data processing units, the instructions executed by the processor of the computer or the other programmable data processing units generate means capable of performing functions described in the blocks of the block diagram or the operations of the flowchart.

Since the computer program instructions are storable in a computer-available or computer-readable memory for the computer or other programmable data processing units to perform functions using specific methods, the instructions stored in the computer-available or computer-readable memory can produce manufactured articles including instruction means performing functions described in the blocks of the block diagram or the operations of the flowchart.

Also, since the computer program instructions are loadable on the computer or other programmable data processing units, the instructions configured to generate a computer-executable process by performing a series of operations on the computer or other programmable data processing units to operate the computer or other programmable data processing units can provide operations for performing the functions described in the blocks of the block diagram and the operations of the flowchart.

Also, each block or each operation may refer to a part of a module, a segment, or a code including one or more executable instructions for performing specified logical functions, and it should be noted that the functions stated in the blocks or the operations may occur while departing from an order in several replaceable embodiments. For example, two consecutively shown blocks or operations may be substantially performed at the same time or the blocks or operations may be performed in a reverse order of corresponding functions as necessary.

Hereinafter, embodiments of the present invention will be described in detail with reference to the drawings. However, the following embodiments of the present invention may be modified into a variety of other forms, and the scope of the present invention is not limited to the embodiments which will be described below. The embodiments of the present invention are provided to more completely explain the present invention to one of ordinary skill in the art.

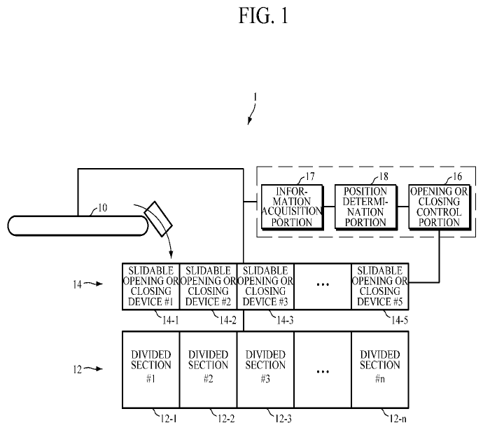

FIG. 1 is a view illustrating a configuration of a cargo sorter according to one embodiment of the present invention.

Referring to FIG. 1, a cargo sorter 1 may include a plurality of divided sections 12, a plurality of slidable opening or closing devices 14, an opening or closing control portion 16, an information acquisition portion 17, and a position determination portion 18 and further include a transfer portion 10.

The transfer portion 10 transfers cargo or changes a transfer direction. The cargo to be transferred or diverted by the transfer portion 10 drops or slides downward into a particular position. The term “downward” is not limited to the particular position and may be determined according to a local environment. For example, the term “downward” may mean a lateral surface of the transfer portion 10 or may be a frontward direction of the transfer portion 10. The transfer portion 10 according to one embodiment is a conveyer structure for conveying cargo and may convey cargo using a conveyer belt. In this case, the cargo moves along the conveyer belt and then drops or slides downward. While the transfer direction is changed, the transfer portion 10 may change the transfer direction of the cargo using a sliding method of laterally pushing and sorting cargo, a wheel method of rotating and sorting cargo, and the like.

A plurality of divided sections 12-1, 12-2, . . . , and 12-n in which spaces are separated from each other are located at an inlet position where the cargo drops or slides from the transfer portion 10. The plurality of divided sections 12-1, 12-2, . . . , and 12-n may be located in a row below a front of the transfer portion 10 and may be located in a row below one surface of the transfer portion 10. The plurality of divided sections 12-1, 12-2, . . . , and 12-n are in one group in FIG. 1 but may be divided into several groups. For example, some groups may be located below one surface of the transfer portion 10, and other groups may be located below another surface of the transfer portion 10.

The plurality of divided sections 12-1, 12-2, . . . , and 12-n according to one embodiment are arranged in a row. Although a structure in which the plurality of divided sections 12-1, 12-2, . . . , and 12-n are arranged in a row in a longitudinal direction of the transfer portion 10 is shown in FIG. 1, the present invention is extendable to a structure in which the plurality of divided sections 12-1, 12-2, . . . , and 12-n are arranged in a vertical direction perpendicular to the longitudinal direction.

A plurality of slidable opening or closing devices 14-1, 14-2, and 14-3 are formed in a row to be inclined so as to sort cargo by using an inclined surface for transferring cargo and changing an approach path of the cargo using a method of opening a door through an operation. The plurality of slidable opening or closing devices 14-1, 14-2, and 14-3 are arranged in a row and the inclined surface thereof is utilized as a cargo transfer means so as to obtain an effect of expanding a discharge chute at a low cost. Accordingly, an installation cost and an installation scale may be reduced.

The information acquisition portion 17 acquires sorting information of cargo. The information acquisition portion 17 may use an imaging device to acquire the sorting information. The vision apparatus acquires an image of each piece of the cargo transferred or diverted by the cargo sorter and analyzes the acquired image to acquire sorting information of each piece of the cargo. For example, multiple pieces of cargo are sorted by acquiring an image of cargo using the vision apparatus, recognizing identification information of the cargo from the acquired image, and referring to sorting information matched with the identification information of each piece of the cargo using the recognized identification information of each piece of the cargo. There are present a variety of identification information recognition methods including, for examples, a barcode reading (BCR) method, a sorting code reading method, a video coding (VCD) method, an optical character reading (OCR) method, and the like.

The position determination portion 18 determines a cargo proceeding path including a destination section into which cargo is finally discharged using the cargo sorting information acquired by the information acquisition portion 17 and controls cargo movement along the determined proceeding path.

The opening or closing control portion 16 controls each of the slidable opening or closing devices such that the cargo is discharged into the destination section determined by the position determination portion 18. The opening or closing control portion 16 opens or closes the door by separately controlling an operation of each of the slidable opening or closing devices 14-1, 14-2, and 14-3. Here, the opening or closing control portion 16 may separately control the plurality of slidable opening or closing devices 14-1, 14-2, and 14-3 at the same time using only a single driving portion, such as a motor and a cylinder, commonly used by the slidable opening or closing devices 14-1, 14-2, and 14-3.

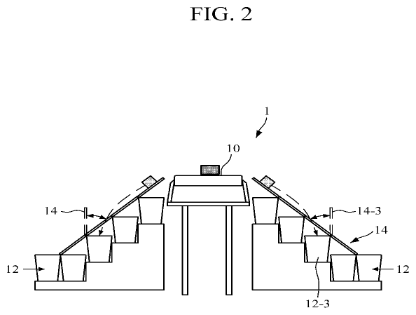

FIG. 2 is a side view illustrating the cargo sorter according to one embodiment of the present invention.

Referring to FIGS. 1 and 2, the divided sections 12 and the slidable opening or closing devices 14 are located on both sides of the transfer portion 10 but positions thereof are not limited thereto. For example, they may be located on a front surface of the transfer portion 10. Also, although the cargo sorter includes the transfer portion 10 in FIG. 2, the cargo sorter may include only the divided sections 12 and the slidable opening or closing devices 14 without the transfer portion 10 and the inclined surface of the slidable opening or closing device 14 may be utilized as the transfer portion 10.

Each of the slidable opening or closing devices 14 is formed on a top end of each of the divided sections 12 and is configured according to a top plate which is opened or closed by the door. In this case, the opening or closing control portion 16 opens the door of the slidable opening or closing device formed on the top end of the destination section among the divided sections such that the cargo is to be loaded on the corresponding divided section. Here, a plurality of such destination sections may be present. As another example, before the cargo approaches the destination section, previous slidable opening or closing devices, which are closed, subsequently transfer the cargo to the next slidable opening or closing devices and the slidable opening or closing device located on the top end of the destination section may be opened so as to load the cargo on a destination section at a bottom end thereof. Here, since each of the slidable opening or closing devices 14 has an inclined shape, the closed slidable opening or closing devices may be used as inclined surfaces which allow the cargo to slide thereon and move toward the net slidable opening or closing device.

The opening or closing control portion 16 separately controls operations of the slidable opening or closing devices 14 at the same time. The opening or closing control portion 16 changes the approach path of the cargo from an approach position where the cargo drops or slides to a destination section among five divided sections 12, for example, a divided section #3 12-3 so as to allow the cargo to be sorted and loaded on the destination section. For example, a door of a slidable opening or closing device #3 14-3 formed on a top end of the divided section #2 12-3 to load the cargo on a certain divided section #2 14-3. The above-described method of sorting and loading cargo by changing an approach path of the cargo is applicable to all conveying methods of the transfer portion 10. For example, the method may be applied to all of a slide-chute sorting method of sorting cargo transferred by the transfer portion 10 by laterally pushing the cargo, a wheel sorting method of sorting transferred cargo by rotating a direction of the cargo, a tilt-tray method of discharging cargo by tilting a transfer tray, and a cross belt sorting method of discharging cargo by rotating a belt.

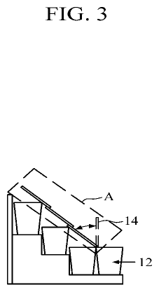

FIG. 3 is a side view illustrating the driving device of FIG. 2 according to one embodiment of the present invention.

Referring to FIG. 3, the opening or closing control portion 14 of FIG. 1 employs one cylinder or motor as the driving portion, selectively applies an electrical signal to a solenoid, and determines whether to open or close each of the slidable opening or closing devices. The solenoid may be an electromagnet. The solenoid is replaceable with a switch capable of being turned on or off. Here, an electrical signal is applied to only the slidable opening or closing device with the door to be opened such that the corresponding door is opened. The other slidable opening or closing devices are blocked from an electrical signal such that the doors thereof are closed.

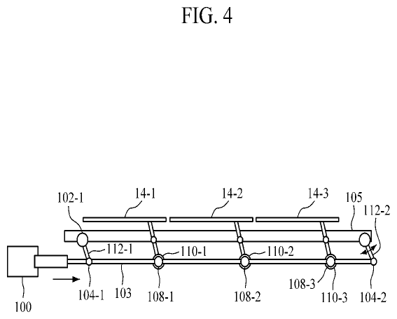

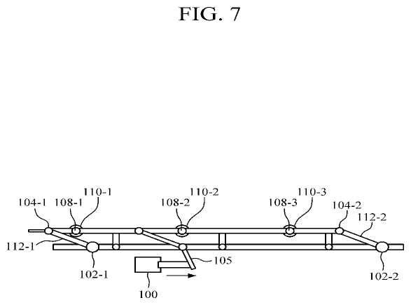

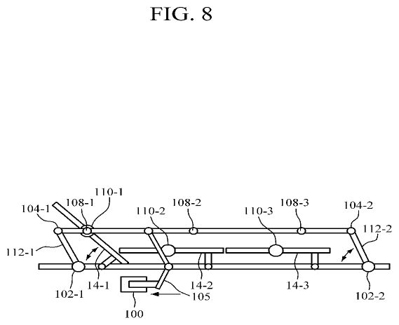

Part A of FIG. 3 is a part for transferring opening or closing power formed using a method of connecting a link structure divided into a parallelogram and the like to a top of the slidable opening or closing device (refer to FIGS. 4 to 6), a method of connecting the link structure to a bottom of the slidable opening or closing device with an extension shaft (refer to FIGS. 7 and 8), and the like.

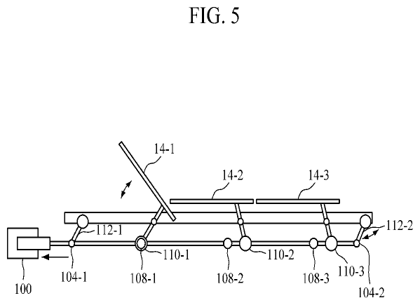

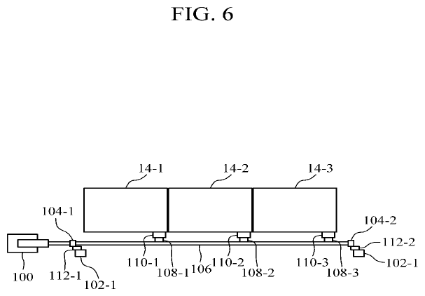

FIGS. 4 to 6 are views illustrating a detailed structure of the driving device of FIG. 2 according to one embodiment of the present invention. In detail, FIG. 4 is a side view of the cargo sorter in a state in which the slidable opening or closing device is closed. FIG. 5 is a side view of the cargo sorter in a state in which the slidable opening or closing device is selectively opened. FIG. 6 is a front view of the cargo sorter in the state in which the slidable opening or closing device is closed.

Referring to FIGS. 1 and 4 to 6, the cargo sorter sorts cargo by controlling opening or closing the doors of the slidable opening or closing devices 14-1 14-2, and 14-3. To this end, the slidable opening or closing devices 14-1, 14-2, and 14-3 may become slide plates for a slide. Here, the slidable opening or closing devices 14-1, 14-2, and 14-3 allow the cargo to slide along inclined partitions when the doors thereof are closed and to freely drop toward an opened space when the doors are opened. When the opening or closing control portion 16 is driven using a single cylinder, motor, or the like, the opening or closing control portion 16 selectively applies an electrical control signal to the slidable opening or closing device for sorting and opens the corresponding slidable opening or closing device.

The opening or closing control portion 16 according to one embodiment includes a driving portion 100, a link structure, a plurality of first solenoids 108-1, 108-2, and 108-3 and a plurality of second solenoids 110-1, 110-2, and 110-3.

The driving portion 100 may be a cylinder, a motor, or the like. FIGS. 4 to 6 illustrate a cylinder. Here, it is possible to simultaneously control the slidable opening or closing devices 14-1, 14-2, and 14-3 using only the single driving portion 100.

The link structure includes a fixing bar 101, fixing shafts 102-1 and 102-2 mounted on both ends of the fixing bar 101, a moving bar 103 formed to be spaced apart to be parallel from the fixing bar 101 and coupled with the driving portion 100 to be moved by driving of the driving portion 100, links 104-1 and 104-2 mounted on both ends of the moving bar 103, and connection members 112-1 and 112-2 configured to connect the links 104-1 and 104-2 to the fixing shafts 102-1 and 102-2. The link structures form a parallelogram structure in FIGS. 4 and 5 but a shape thereof is not limited thereto.

The plurality of first solenoids 108-1, 108-2, and 108-3 are formed between both links 104-1 and 104-2 of the moving bar for the slidable opening or closing devices 14-1, 14-2, and 14-3 and move while the links 104-1 and 104-2 move. The plurality of second solenoids 110-1, 110-2, and 110-3 are mounted in positions corresponding to the first solenoids for the slidable opening or closing devices 14-1, 14-2, and 14-3 and generate coupling forces with the first solenoids due to an electrical signal to move with the first solenoids. When an electrical signal is not generated, the coupling forces with the first solenoids are released. Here, when the first solenoid and the second solenoid, which correspond to each other, are coupled with each other, the door of the corresponding slidable opening or closing device may be opened or closed. When the coupling between the first solenoid and the second solenoid is released, the door of the corresponding slidable opening or closing device does not move and stops in the present state with no regard to the driving portion 100.

For example, referring to FIG. 5, a first solenoid 108-1 and a second solenoid 110-1, which correspond to a slidable opening or closing device #1 14-1 among the slidable opening or closing devices 14-1, 14-2, and 14-3, are coupled with each other according to an electrical signal such that the slidable opening or closing device #1 14-1 moves and is opened, other slidable opening or closing devices #2 and #3 14-2 and 14-3 stop in the present state in which the corresponding first and second solenoids are separate from each other since an electrical signal is not applied, and then the corresponding slidable opening or closing devices #2 and #3 14-2 and 14-3 are closed without change.

FIGS. 7 and 8 are views illustrating a detailed structure of the driving device of FIG. 2 according to another embodiment of the present invention. In detail, FIG. 7 is a side view of the cargo sorter in a state in which the slidable opening or closing device is closed, and FIG. 8 is a side view of the cargo sorter in a state in which the slidable opening or closing device is selectively.

Referring to FIGS. 1, 7, and 8, the opening or closing control portion 16 includes a driving portion 100, a link structure, a plurality of first solenoids 108-1, 108-2, and 108-3 and a plurality of second solenoids 110-1, 110-2, and 110-3.

The link structure includes a fixing bar 101, fixing shafts 102-1 and 102-2 mounted on both ends of the fixing bar 101, a moving bar 103 formed to be spaced apart to be parallel from the fixing bar 101 and coupled with the driving portion 100 through a power transmission portion 105 to be moved by driving of the driving portion 100, links 104-1 and 104-2 mounted on both ends of the moving bar 103, and connection members 112-1 and 112-2 configured to connect the links 104-1 and 104-2 to the fixing shafts 102-1 and 102-2. The link structures form a parallelogram structure in FIGS. 7 and 8 but a shape thereof is not limited thereto. The power transmission portion 105 connects the driving portion 100, the fixing bar 101, and the moving bar 103 and rotates a fixing shaft of the fixing bar 10 to move the moving bar 103 when the driving portion 100 is driven.

The plurality of first solenoids 108-1, 108-2, and 108-3 are formed between both links 104-1 and 104-2 of the moving bar 103 for the slidable opening or closing devices 14-1, 14-2, and 14-3 and move while the links 104-1 and 104-2 move. The plurality of second solenoids 110-1, 110-2, and 110-3 are mounted in positions corresponding to the first solenoids for the slidable opening or closing devices and generate coupling forces with the first solenoids due to an electrical signal to move with the first solenoids. When an electrical signal is not generated, the coupling forces with the first solenoids are released.

When the first solenoids and the second solenoids which correspond to each other are coupled, the door of the corresponding slidable opening or closing device may be opened or closed. On the other hand, when the coupling between the first solenoid and the second solenoid is released, the door of the corresponding slidable opening or closing device does not move and stops in the present state with no regard to the driving portion 100.

For example, referring to FIG. 8, while all the slidable opening or closing devices 14-1, 14-2, and 14-3 are closed, the first solenoid 108-1 and the second solenoid 110-1, which correspond to the slidable opening or closing device #1 14-1 among the slidable opening or closing devices 14-1, 14-2, and 14-3, are coupled with each other according to an electrical signal such that the corresponding slidable opening or closing device #1 14-1 moves and is opened, other slidable opening or closing devices #2 and #3 14-2 and 14-3 stop in the present state in which the corresponding first and second solenoids are separate from each other since an electrical signal is not applied thereto, and then the corresponding slidable opening or closing devices #2 and #3 14-2 and 14-3 are closed without change.

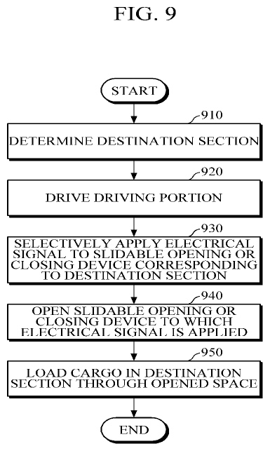

FIG. 9 is a flowchart illustrating a cargo classification method according to one embodiment of the present invention.

Referring to FIGS. 1 and 4 to 9, the cargo sorter 1 determines a certain destination section among a plurality of divided sections where cargo is loaded (910). Here, the destination section may be determined using sorting information of the cargo. Subsequently, the single driving portion 100 is driven (920). Also, when the driving portion 100 is driven, an electrical signal is applied to a slidable opening or closing device corresponding to the determined destination section (930). The slidable opening or closing device to which the electrical signal is applied is opened (940) such that the cargo is loaded in the destination section through an opened space (950).

In operation 930 of applying the electrical signal, an electrical signal is applied at the same time to the slidable opening or closing device selected while the driving portion is driven such that it is possible to sort the cargo in the plurality of divided sections through driving only once. In operation 930 of applying the electrical signal, in the case of the slidable opening or closing device to which the electrical signal is applied, a first solenoid and a second solenoid, which are formed in positions corresponding to each other, are coupled with each other such that the first solenoid or the second solenoid, which is coupled with the corresponding slidable opening or closing device, moves and opens or closes a door of the corresponding slidable opening or closing device. In the case of other slidable opening or closing devices to which the electrical signal is not applied, coupling between the first solenoid and the second solenoid, which correspond to each other, is released such that doors thereof may remain without change.

The embodiments of the present invention have been described above. It should be understood by one of ordinary skill in the art that the present invention may be implemented as a modified form without departing from the essential features of the present invention. Therefore, the disclosed embodiments should be considered not in a limitative view but in a descriptive view. The scope of the present invention will be shown in the claims not in the above description, and all differences within an equivalent range thereof should be interpreted as being included in the present invention.

1. A cargo sorter comprising:
a plurality of divided sections which form a separate space;
a plurality of slidable opening or closing devices which each have an inclined surface formed in a row at a position corresponding to each of the divided sections to be inclined as an openable or closable door so as to transfer cargo using the inclined surface and to sort the cargo by changing an approach path of the cargo by opening the door;
a position determination portion configured to determine a cargo proceeding path including a destination section where the cargo is finally discharged and to control movement of the cargo along the determined proceeding path; and
an opening or closing control portion configured to control opening or closing of each of the slidable opening or closing devices so as to discharge the cargo into the destination section determined by the position determination portion.

2. The cargo sorter of claim 1, wherein the slidable opening or closing devices are installed in a row on top ends of the divided sections to be inclined as the openable or closable doors so as to transfer the cargo by sliding the cargo when they are closed and to drop the cargo through an open space toward the divided section therebelow when they are opened.

3. The cargo sorter of claim 1, wherein the opening or closing control portion separately controls operations of the slidable opening or closing devices at the same time using a single driving portion commonly used by the slidable opening or closing devices.

4. The cargo sorter of claim 1, wherein, when a driving portion is driven, the opening or closing control portion selectively applies an electrical signal to a solenoid and determines whether to open or close each of the slidable opening or closing devices.

5. The cargo sorter of claim 1, wherein the opening or closing control portion comprises:
a single driving portion including a cylinder or a motor;
a link structure comprising a fixing bar, fixing shafts mounted on both ends of the fixing bar, a moving bar formed to be spaced apart to be parallel from the fixing bar and coupled with the driving portion to be moved by driving of the driving portion, links mounted on both ends of the moving bar, and a connection member configured to connect the fixing shafts to the links;
a plurality of first solenoids formed between both of the links of the moving bar to move while the links move; and
a plurality of second solenoids each mounted in a position corresponding to each of the first solenoids for each of the slidable opening or closing devices to generate a coupling force with the first solenoid due to an electrical signal and move with the first solenoid, in which the coupling force with the first solenoid is released when the electrical signal is not generated, and
wherein, when the first solenoid and the second solenoid, which correspond to each other, are coupled with each other, a door of the corresponding slidable opening or closing device is openable or closable, and when coupling between the first solenoid and the second solenoid is released, the door of the corresponding slidable opening or closing device does not move and stops in the present state with no regard to the driving portion.

6. The cargo sorter of claim 1, wherein the opening or closing control portion comprises:
a single driving portion including a cylinder or a motor;
a link structure comprising a fixing bar, fixing shafts mounted on both ends of the fixing bar, a moving bar formed to be spaced apart to be parallel from the fixing bar and coupled with the driving portion through a power transmission portion to be moved by driving of the driving portion, links mounted on both ends of the moving bar, and a connection member configured to connect the fixing shafts to the links;
the power transmission portion configured to connect the driving portion, the fixing bar, and the moving bar and to move the moving bar by rotating on a fixing shaft of the fixing bar when the driving portion is driven;
a plurality of first solenoids formed between both of the links of the moving bar to move while the links move; and
a plurality of second solenoids each mounted in a position corresponding to each of the first solenoids for each of the slidable opening or closing devices to generate a coupling force with the first solenoid due to an electrical signal and move with the first solenoid, in which the coupling force with the first solenoid is released when the electrical signal is not generated, and
wherein, when the first solenoid and the second solenoid, which correspond to each other, are coupled with each other, a door of the corresponding slidable opening or closing device is openable or closable, and when coupling between the first solenoid and the second solenoid is released, the door of the corresponding slidable opening or closing device does not move and stops in the present state with no regard to the driving portion.

7. The cargo sorter of claim 1, wherein before the cargo approaches the destination section, previous slidable opening or closing devices, which are closed, subsequently transfer the cargo to the next slidable opening or closing devices, and the slidable opening or closing device located on a top end of the destination section is opened so as to load the cargo on a destination section at a bottom end thereof.

8. The cargo sorter of claim 1, further comprising a transfer portion configured to transfer or divert the cargo,
wherein the divided sections form a space separated from an approach position, in which the cargo transferred or diverted by the transfer portion drops or slides, and
wherein the slidable opening or closing devices are formed between the transfer portion and the divided sections.

9. A method of sorting cargo, comprising:
determining a certain destination section, on which the cargo is to be loaded, among a plurality of divided sections;
driving a single driving portion;
applying an electrical signal to a slidable opening or closing device corresponding to the determined destination section while the driving portion is driven; and
loading the cargo on the destination section through an opened space as the slidable opening or closing device, to which the electrical signal is applied, is opened.

10. The method of claim 9, wherein the applying of the electrical signal comprises, when the driving portion is driven, determining whether to open or close each of such slidable opening or closing devices by selectively applying the electrical signal to a solenoid.

11. The method of claim 9, wherein in the applying of the electrical signal, in the case of the slidable opening or closing device to which the electrical signal is applied, a first solenoid and a second solenoid, which are formed in positions corresponding to each other, are coupled with each other such that the first solenoid or the second solenoid, which is coupled with the corresponding slidable opening or closing device, moves and opens or closes a door of the corresponding slidable opening or closing device, and in the case of other slidable opening or closing devices to which the electrical signal is not applied, coupling between a first solenoid and a second solenoid, which correspond to each other, is released such that doors thereof may remain without change.
